(19) United States
(12) Patent Application Publication
(10) Pub. No.: US 2006/0186088 A1
(43) Pub. Date: Aug. 24, 2006

(54) Etching and cleaning BPSG material using supercritical processing

(76) Inventors: Gunilla Jacobson, Menlo Park, CA (US); Robert Kevwitch, Chandler, AZ (US); Marie Lowe, Gilbert, AZ (US)

Correspondence Address: HAVERSTOCK & OWENS LLP, 162 NORTH WOLFE ROAD, SUNNYVALE, CA, 94086, US

(21) Appl. No.: 11/065,376

(22) Filed: Feb. 23, 2005

(51) Int. Cl. B08B 6/00; B44C 1/22; C23F 1/00

(52) U.S. Cl. 216/83; 134/1.3

(57) ABSTRACT

A method for etching and removing post-etch residue from a BPSG material is disclosed. In accordance with the method of the present invention, the BPSG material is etched and the residue is removed from the substrate structure using supercritical solutions.

### CROSS-REFERENCE TO RELATED APPLICATIONS

This patent application is related to commonly owned co-pending U.S. patent application Ser. No. (SSI 05900), filed ______, entitled “IMPROVED RINSING STEP IN SUPERCRITICAL PROCESSING” and U.S. patent application Ser. No. (SSI 05901), filed ______, entitled “IMPROVED CLEANING STEP IN SUPERCRITICAL PROCESSING”, which are hereby incorporated by reference in its entirety.

### FIELD OF THE INVENTION

The present invention relates to the field of etching features on semiconductor devices or other objects. More particularly, the present invention relates to the field of etching using supercritical processing.

### BACKGROUND OF THE INVENTION

It is well known in the industry that particulate surface contamination of semiconductor wafers typically degrades device performance and affects yield. When processing wafers, it is desirable that particles and contaminants such as but not limited to photoresist, photoresist residue, and residual etching reactants and byproducts be minimized.

Supercritical fluids have been suggested for the cleaning of semiconductor wafers (e.g., an approach to using supercritical carbon dioxide to remove exposed organic photoresist film is disclosed in U.S. Pat. No. 4,944,837 to Nishikawa, et al., entitled “Method of Processing an Article in a Supercritical Atmosphere,” issued Jul. 31, 1990). A fluid enters the supercritical state when it is subjected to a combination of pressure and temperature at which the density of the fluid approaches that of a liquid, and the diffusivity remains comparable to a gas. Supercritical fluids exhibit properties of both a liquid and a gas. For example, supercritical fluids are characterized by solvating and solubilizing properties that are typically associated with compositions in the liquid state. Supercritical fluids also have a low viscosity that is characteristic of compositions in the gaseous state.

A problem in semiconductor manufacturing is that the cleaning step generally does not completely remove photoresist residue and other residues and contaminants on the surface of the wafer. It would be advantageous after the cleaning step to be able to remove the photoresist residue and contaminants from the surface features on the wafer surface.

What is needed is an effective method of etching features on a substrate and removing a residue from one or more feature surfaces on the substrate.

### SUMMARY OF THE INVENTION

One embodiment of the present invention includes a method of etching features on a substrate and removing a residue from one or more feature surfaces on the substrate.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a processing system in accordance with an embodiment of the invention;

FIGS. 2 illustrates exemplary graphs of pressure versus time for supercritical processes in accordance with embodiments of the invention; and

FIG. 3 illustrates a flow chart of a method of etching features on a substrate and removing a residue from one or more feature surfaces on the substrate in accordance with embodiments of the present invention.

### DETAILED DESCRIPTION OF SEVERAL EMBODIMENTS

The present invention is directed to an apparatus and methods of etching, cleaning, and/or rinsing features and feature surfaces of a substrate using supercritical processing. The methods and apparatus in accordance with the present invention utilize the low viscosity and solvating and solubilizing properties of supercritical carbon dioxide to assist in etching, cleaning, and rinsing process. For purposes of the invention, “carbon dioxide” should be understood to refer to carbon dioxide (CO₂) employed as a fluid in a liquid, gaseous or supercritical (including near supercritical) state. “Supercritical carbon dioxide” refers herein to CO₂ at conditions above the critical temperature (31.1° C.) and critical pressure (7.38 MPa). When CO₂ is subjected to pressures and temperatures above 7.38 MPa and 31.1° C., respectively, it is determined to be in the supercritical state.

Various objects can be processed using the apparatus and methods of the present invention. For the purposes of the invention, “object” typically refers to semiconductor wafers, substrates, and other media requiring low contamination levels. As used herein, “substrate” includes a wide variety of structures such as semiconductor device structures typically with a deposited photoresist or residue. A substrate can be a single layer of material, or can include any number of layers. A substrate can comprise various materials, including semiconductors, metals, ceramics, glass, or compositions thereof.

A wide variety of materials can be effectively etched and cleaned using the methods and apparatus of the invention. For example, a substrate can comprise at least one of Boron-Doped Phosphosilicate Glass (BPSG) material, polysilicon material, and photoresist material. The methods and apparatus of the invention are particularly advantageous for the etching materials having thicknesses up to approximately 2.0 microns and having critical dimensions below approximately 0.25 microns.

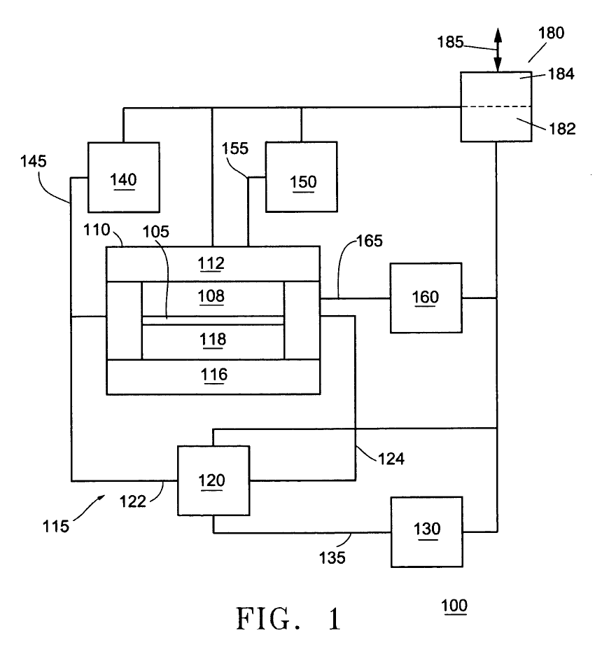

FIG. 1 shows an exemplary block diagram of a processing system in accordance with an embodiment of the invention. In the illustrated embodiment, processing system 100 comprises a process module 110, a recirculation system 120, a process chemistry supply system 130, a high-pressure fluid supply system 140, an exhaust control system 150, a pressure control system 160, and a controller 180. The processing system 100 can operate at pressures that can range from 1000 psi. to 10,000 psi. In addition, the processing system 100 can operate at temperatures that can range from 40 to 300 degrees Celsius.

The details concerning one example of a processing chamber are disclosed in co-owned and co-pending U.S. patent applications Ser. No. 09/912,844, entitled “HIGH PRESSURE PROCESSING CHAMBER FOR SEMICONDUCTOR SUBSTRATE,” filed Jul. 24, 2001, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are incorporated herein by reference.

The controller 180 can be coupled to the process module 110, the recirculation system 120, the process chemistry supply system 130, the high-pressure fluid supply system 140, the exhaust system 150, and the pressure control system 160. Alternately, controller 180 can be coupled to one or more additional controllers/computers (not shown), and controller 180 can obtain setup and/or configuration information from an additional controller/computer.

In FIG. 1, singular processing elements (110, 120, 130, 140, 150, 160, and 180) are shown, but this is not required for the invention. The semiconductor processing system 100 can comprise any number of processing elements having any number of controllers associated with them in addition to independent processing elements.

The controller 180 can be used to configure any number of processing elements (110, 120, 130, 140, 150, and 160), and the controller 180 can collect, provide, process, store, and display data from processing elements. The controller 180 can comprise a number of applications for controlling one or more of the processing elements. For example, controller 180 can include a GUI component (not shown) that can provide easy to use interfaces that enable a user to monitor and/or control one or more processing elements.

The process module 110 can include an upper assembly 112 and a lower assembly 116, and the upper assembly 112 can be coupled to the lower assembly 116. In an alternate embodiment, a frame and/or injection ring may be included and may be coupled to an upper assembly and/or a lower assembly. In one embodiment, the process module 110 can include a holder or chuck 118 for supporting and holding the substrate 105 while processing the substrate 105. The holder or chuck 118 can also be configured to heat or cool the substrate 105 before, during, and/or after processing the substrate 105. Alternately, the process module 110 can include a platen for supporting and holding the substrate 105 while processing the substrate 105.

The process module 110 can include means for flowing a processing fluid through the processing chamber 108. In one example, a circular flow pattern can be established, and in another example, a substantially linear flow pattern can be established. Alternately, the means for flowing can be configured differently. The lower assembly 116 can comprise one or more lifters (not shown) for moving the chuck 118 and/or the substrate 105. Alternately, a lifter is not required. The upper assembly 112 can comprise a heater (not shown) for heating the process chamber, the substrate, or the processing fluid, or a combination of two or more thereof. Alternately, a heater is not required in the upper assembly 112. In another embodiment, the lower assembly 116 can comprise a heater (not shown) for heating the process chamber, the substrate, or the processing fluid, or a combination of two or more thereof.

A transfer system (not shown) can be used to move a substrate into and out of the processing chamber 108 through a slot (not shown). In one example, the slot can be opened and closed by moving the chuck, and in another example, the slot can be controlled using a gate valve.

The substrate can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, Ta, or W, or combinations of two or more thereof. The dielectric material can include Si, O, N, H, P, or C, or combinations of two or more thereof. The ceramic material can include Al, N, Si, C, or 0, or combinations of two or more thereof.

In one embodiment, the recirculation system can be coupled to the process module 110 using one or more inlet lines 122 and one or more outlet lines 124, and a recirculation loop 115 can be configured that includes a portion of the recirculation system, a portion of the process module 110, one or more of the inlet lines 122, and one or more of the outlet lines 124. In one embodiment, the recirculation loop 115 comprises a volume of approximately one liter. In alternate embodiments, the volume of the recirculation loop 115 can vary from approximately 0.5 liters to approximately 2.5 liters.

The recirculation system 120 can comprise one or more pumps (not shown), can be used to regulate the flow of the supercritical processing solution through the processing chamber 108 and the other elements in the recirculation loop 115. The flow rate can vary from approximately 0.01 liters/minute to approximately 100 liters/minute.

The recirculation system 120 can comprise one or more valves (not shown) for regulating the flow of a supercritical processing solution through the recirculation loop 115. For example, the recirculation system 120 can comprise any number of back-flow valves, filters, pumps, and/or heaters (not shown) for maintaining a supercritical processing solution and flowing the supercritical process solution through the recirculation system 120 and through the processing chamber 108 in the process module 110.

Processing system 100 can comprise a process chemistry supply system 130. In the illustrated embodiment, the process chemistry supply system is coupled to the recirculation system 120 using one or more lines 135, but this is not required for the invention. In alternate embodiments, the process chemistry supply system can be configured differently and can be coupled to different elements in the processing system.

The process chemistry is introduced by the process chemistry supply system 130 into the fluid introduced by the high-pressure fluid supply system 140 at ratios that vary with the substrate properties, the chemistry being used, and the process being performed in the processing chamber 110. The ratio can vary from approximately 0.001 to approximately 15 percent by volume. For example, when the recirculation loop 115 comprises a volume of about one liter, the process chemistry volumes can range from approximately ten microliters to approximately one hundred fifty milliliters. In alternate embodiments, the volume and/or the ratio may be higher or lower.

The process chemistry supply system 130 can comprise etching and/or cleaning chemistry assemblies (not shown) for providing etching/cleaning chemistry for generating supercritical etching/cleaning solutions within the processing chamber. The cleaning chemistry can include chelating agents, complexing agents, oxidizers, acids, amines, or other organic solvents that can be introduced into supercritical carbon dioxide with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

The process chemistry supply system 130 can comprise a rinsing chemistry assembly (not shown) for providing rinsing chemistry for generating supercritical rinsing solutions within the processing chamber. The rinsing chemistry can include one or more organic solvents including, but not limited to, alcohols and ketones. In one embodiment, the rinsing chemistry can comprise an alkylene carbonate and a carrier solvent. The process chemistry supply system 130 can comprise a drying chemistry assembly (not shown) for providing drying chemistry for generating supercritical drying solutions within the processing chamber.

Furthermore, the processing chemistry can include solvents, co-solvents, surfactants, and/or other ingredients. Examples of solvents, co-solvents, and surfactants are disclosed in co-owned U.S. Pat. No. 6,500,605, entitled “REMOVAL OF PHOTORESIST AND RESIDUE FROM SUBSTRATE USING SUPERCRITICAL CARBON DIOXIDE PROCESS”, issued Dec. 31, 2002, and U.S. Pat. No. 6,277,753, entitled “REMOVAL OF CMP RESIDUE FROM SEMICONDUCTORS USING SUPERCRITICAL CARBON DIOXIDE PROCESS”, issued Aug. 21, 2001, both are incorporated by reference herein.

The processing system 100 can comprise a high-pressure fluid supply system 140. As shown in FIG. 1, the high-pressure fluid supply system 140 can be coupled to the recirculation system 120 using one or more lines 145, but this is not required. The inlet line 145 can be equipped with one or more back-flow valves, and/or heaters (not shown) for controlling the fluid flow from the high-pressure fluid supply system 140. In alternate embodiments, high-pressure fluid supply system 140 can be configured differently and coupled differently. For example, the high-pressure fluid supply system 140 can be coupled to the process module 110.

The high-pressure fluid supply system 140 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high-pressure fluid supply system 140 can comprise an inlet valve (not shown) that is configured to open and close to allow or prevent the stream of supercritical carbon dioxide from flowing into the processing chamber 108. For example, controller 180 can be used to determine fluid parameters such as pressure, temperature, process time, and flow rate.

The processing system 100 can also comprise a pressure control system 160. As shown in FIG. 1, the pressure control system 160 can be coupled to the process module 110 using one or more lines 165, but this is not required. Line 165 can be equipped with one or more back-flow valves, pumps, and/or heaters (not shown) for controlling the fluid flow to pressure control system 160. In alternate embodiments, pressure control system 160 can be configured differently and coupled differently. For example, the pressure control system 160 can also include one or more pumps (not shown), and a sealing means (not shown) for sealing the processing chamber. In addition, the pressure control system 160 can comprise means for raising and lowering the substrate and/or the chuck.

In addition, the processing system 100 can comprise an exhaust control system 150. Alternately, an exhaust system may not be required. As shown in FIG. 1, the exhaust control system 150 can be coupled to the process module 110 using one or more lines 155, but this is not required. Line 155 can be equipped with one or more back-flow valves, and/or heaters (not shown) for controlling the fluid flow to the exhaust control system 150. In alternate embodiments, exhaust control system 150 can be configured differently and coupled differently. The exhaust control system 150 can include an exhaust gas collection vessel (not shown) and can be used to remove contaminants from the processing fluid. Alternately, the exhaust control system 150 can be used to recycle the processing fluid.

In one embodiment, controller 180 can comprise a processor 182 and a memory 184. Memory 184 can be coupled to processor 182, and can be used for storing information and instructions to be executed by processor 182. Alternately, different controller configurations can be used. In addition, controller 180 can comprise a port 185 that can be used to couple processing system 100 to another system (not shown). Furthermore, controller 180 can comprise input and/or output devices (not shown).

In addition, one or more of the processing elements (110, 120, 130, 140, 150, 160, and 180) may include memory (not shown) for storing information and instructions to be executed during processing and processors for processing information and/or executing instructions. For example, the memory may be used for storing temporary variables or other intermediate information during the execution of instructions by the various processors in the system. One or more of the processing elements can comprise the means for reading data and/or instructions from a computer readable medium. In addition, one or more of the processing elements can comprise the means for writing data and/or instructions to a computer readable medium.

Memory devices can include at least one computer readable medium or memory for holding computer-executable instructions programmed according to the teachings of the invention and for containing data structures, tables, records, or other data described herein.

The processing system 100 can perform a portion or all of the processing steps of the invention in response to the controller 180 executing one or more sequences of one or more computer-executable instructions contained in a memory. Such instructions may be received by the controller from another computer, a computer readable medium, or a network connection.

Stored on any one or on a combination of computer readable media, the present invention includes software for controlling the processing system 100, for driving a device or devices for implementing the invention, and for enabling the processing system 100 to interact with a human user and/or another system, such as a factory system. Such software may include, but is not limited to, device drivers, operating systems, development tools, and applications software. Such computer readable media further includes the computer program product of the present invention for performing all or a portion (if processing is distributed) of the processing performed in implementing the invention.

The term “computer readable medium” as used herein refers to any medium that participates in providing instructions to a processor for execution and/or that participates in storing information before, during, and/or after executing an instruction. A computer readable medium may take many forms, including but not limited to, non-volatile media, volatile media, and transmission media. The term “computer-executable instruction” as used herein refers to any computer code and/or software that can be executed by a processor, that provides instructions to a processor for execution and/or that participates in storing information before, during, and/or after executing an instruction.

Controller 180, processor 182, memory 184 and other processors and memory in other system elements as described thus far can, unless indicated otherwise below, be constituted by components known in the art or constructed according to principles known in the art. The computer readable medium and the computer executable instructions can also, unless indicated otherwise below, be constituted by components known in the art or constructed according to principles known in the art.

Controller 180 can use port 185 to obtain computer code and/or software from another system (not shown), such as a factory system. The computer code and/or software can be used to establish a control hierarchy. For example, the processing system 100 can operate independently, or can be controlled to some degree by a higher-level system (not shown).

Controller 180 can receive, send, use, and/or generate pre-process data, process data, and post-process data, and this data can include lot data, batch data, run data, composition data, and history data. Pre-process data can be associated with an incoming substrate and can be used to establish an input state for a substrate and/or a current state for a process module. Process data can include process parameters. Post processing data can be associated with a processed substrate and can be used to establish an output state for a substrate

The controller 180 can use the pre-process data to predict, select, or calculate a process recipe to use to process the substrate. A process recipe can include a multi-step process involving a set of process modules. For example, the pre-process data can include information concerning the substrate's materials, the number of layers, the materials used for the different layers, the thickness of materials in the layers, the size of vias and trenches, and a desired process result. Post-process data can be obtained at some point after the substrate has been processed. For example, post-process data can be obtained after a time delay that can vary from minutes to days.

In one embodiment, the controller 180 can compute a predicted state for a substrate based on the pre-process data, the process characteristics, and an etch rate process model. A etch rate process model can provide the relationship between one or more process recipe parameters or set points and one or more process results, such as an etched amount. The controller 180 can compare a predicted value to a measured value to determine when to alter, pause, and/or stop a process. For example, an etching rate model can be used along with a material type and thickness to compute a predicted etching time. In addition, a cleaning rate model can be used along with a residue type and amount to compute a predicted cleaning time. Alternately, a rinse rate model can be used along with a residue type and amount to compute a processing time for a rinse process.

In one embodiment, the substrate can comprise Boron-Doped Phosphosilicate Glass (BPSG) material, a polysilicon material, and a photoresist material. For example, the photoresist material can include photoresist and/or photoresist residue. One process recipe can include steps for etching the BPSG material, removing the photoresist material, and removing the post-etch residue. Another process recipe can include steps for etching the polysilicon material, removing the photoresist material, and removing the post-etch residue.

The controller 180 can be used to monitor and/or control the pressure of the incoming fluids and/or gasses, the pressure of the processing fluids and/or gasses, and the pressure of the exhaust fluids and/or gasses.

It will be appreciated that the controller 180 can perform other functions in addition to those discussed here. The controller 180 can monitor the pressure, temperature, flow, or other variables associated with the processing system 100 and take actions based on these values. For example, the controller 180 can process measured data, such as pressure differential data, display data and/or results on a GUI screen, determine a fault condition, determine a response to a fault condition, and alert an operator and/or another system. In addition, controller 180 use measured data to determine when a system component, such as a sealing device, has failed or is about to fail.

In addition, at least one of the processing elements (110, 120, 130, 140, 150, 160, and 180) can comprise a GUI component and/or a database component (not shown). In alternate embodiments, the GUI component and/or the database component may not be required.

In a supercritical etching/cleaning/rinsing process, the desired process result can be a process result that is measurable using an optical measuring device, such as a SEM. For example, the desired process result can be an amount of contaminant in a fluid, in a via, or on the surface of a substrate. After one or more supercritical processes, the desired process result can be measured.

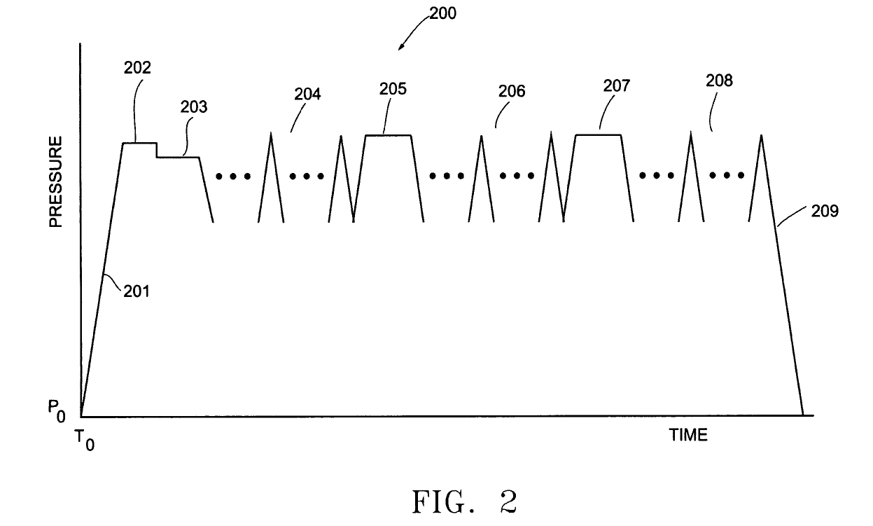

FIG. 2 illustrates an exemplary graph of pressure versus time for a supercritical process step in accordance with an embodiment of the invention. In the illustrated embodiment, a graph 200 of pressure versus time is shown, and the graph 200 can be used to represent a supercritical cleaning process step and a supercritical rinsing process step. Alternately, different pressures, different timing, and different sequences may be used for different processes.

Prior to an initial time To, the substrate to be processed can be placed within the processing chamber 108 and the processing chamber 108 can be sealed. For example, during cleaning and/or rinsing processes, a substrate can have post-etch and/or post-ash residue thereon. The substrate, the processing chamber, and the other elements in the recirculation loop 115 (FIG. 1) can be heated to an operational temperature. For example, the operational temperature can range from 40 to 300 degrees Celsius.

During time 201, the processing chamber 108 and the other elements in the recirculation loop 115 (FIG. 1) can be pressurized. For example, a supercritical fluid, such as substantially pure CO₂, can be used to pressurize the processing chamber 108 and the other elements in the recirculation loop 115 (FIG. 1). During time 201, a pump (not shown), can be started and can be used to circulate the supercritical fluid through the processing chamber 108 and the other elements in the recirculation loop 115 (FIG. 1). For example, the recirculation system 120 can comprise a recirculation pump. In an alternate embodiment, process chemistry may be injected during time 201.

During a second time 202, process chemistry can be introduced. In one embodiment, when the pressure in the processing chamber 108 exceeds a critical pressure Pc (1,070 psi), process chemistry can be injected into the processing chamber 108, using the process chemistry supply system 130. For example, the injection(s) of the process chemistries can begin upon reaching about 1100-1200 psi. In alternate embodiments, process chemistry may be injected into the processing chamber 108 before the pressure exceeds the critical pressure Pc (1,070 psi) using the process chemistry supply system 130. In one embodiment, process chemistry is injected in a linear fashion, and the injection time can be based on a recirculation time. For example, the recirculation time can be determined based on the length of the recirculation path and the flow rate. In other embodiments, process chemistry may be injected in a non-linear fashion. For example, process chemistry can be injected in one or more steps.

The process chemistry can include an etching agent, or a cleaning agent, or a combination thereof that is injected into the supercritical fluid. One or more injections of process chemistries can be performed during time 202 to generate a supercritical processing solution with the desired concentrations of chemicals. The process chemistry, in accordance with the embodiments of the invention, can also include one more or more carrier solvents.

During the second time 202, the supercritical processing solution can also be re-circulated over the substrate and through the processing chamber 108 using the recirculation system 120, such as described above. In one embodiment, process chemistry is not injected during the second time 202. Alternatively, process chemistry may be injected into the processing chamber 108 before the second time 202 or after the second time 202.

In one embodiment, the process chemistry used during one or more steps in the first portion of an etching/cleaning process with a first BPSG material can include gamma-butyrolactone (BLO) and aqueous HF, and the process chemistry used during one or more steps in the second portion of an etching/cleaning process with BPSG material can include oxalic acid and isopropyl alcohol (IPA). Solvents, such as BLO, can be used when photoresist is present on the BPSG material.

In another embodiment, the process chemistry used during one or more steps in the first portion of an etching/cleaning process with a second BPSG material can include gamma-butyrolactone (BLO), and the process chemistry used during one or more steps in the second portion of an etching/cleaning process with BPSG material can include IPA and aqueous HF.

In an additional embodiment, the process chemistry used during one or more steps in the first portion of an etching/cleaning process with a third BPSG material can include IPA and aqueous HF, and the process chemistry used during one or more steps in the second portion of an etching/cleaning process with BPSG material can include oxalic acid and IPA.

The processing chamber 108 can operate at a pressure above 2,200 psi during the second time 202. For example, the pressure can range from approximately 2,500 psi to approximately 3,500 psi, but can be any value so long as the operating pressure is sufficient to maintain supercritical conditions. The supercritical conditions within the processing chamber 108 and the other elements in the recirculation loop 115 (FIG. 1) are maintained during the second time 202, and the supercritical processing solution continues to be circulated over the substrate and through the processing chamber 108 and the other elements in the recirculation loop 115 (FIG. 1). A pump (not shown), can be used to regulate the flow of the supercritical processing solution through the processing chamber 108 and the other elements in the recirculation loop 115 (FIG. 1).

In one embodiment, during the second time 202, the pressure can be substantially constant. Alternately, the pressure may have different values during different portions of the second time 202.

In one embodiment, the process chemistry used during one or more steps in the first portion of an etching/cleaning process with a BPSG material can be injected at a pressure above approximately 2200 psi and circulated at a pressure above approximately 2700 psi. In addition, the process chemistry used during one or more steps in the second portion of an etching/cleaning process with a BPSG material can be injected at a pressure above approximately 2200 psi and circulated at a pressure above approximately 2700 psi. In an alternate embodiment, the process chemistry used during one or more steps in the etching/cleaning process with a BPSG material can be injected at a pressure above approximately 2500 psi and circulated at a pressure above approximately 2500 psi.

During a third time 203, a push-through process can be performed. In an alternate embodiment, a push-through process may not be required after each cleaning step. During the third time 203, a new quantity of supercritical carbon dioxide can be fed into the processing chamber 108 and the other elements in the recirculation loop 115 from the high-pressure fluid supply system 140, and the supercritical etching/cleaning solution along with process residue suspended or dissolved therein can be displaced from the processing chamber 108 and the other elements in the recirculation loop 115 through the exhaust control system 150. In an alternate embodiment, supercritical carbon dioxide can be fed into the recirculation system 120 from the high-pressure fluid supply system 140, and the supercritical etching/cleaning solution along with process residue suspended or dissolved therein can also be displaced from the processing chamber 108 and the other elements in the recirculation loop 115 through the exhaust control system 150.

In one embodiment, at least three decompression cycles can be used after an etching/cleaning process used with a BPSG material. In an alternate embodiment, one or more decompression cycles may be used after an etching/cleaning process used with a BPSG material.

In the illustrated embodiment shown in FIG. 2, a single second time 202 is followed by a single third time 203, but this is not required. In alternate embodiments, other time sequences may be used to process a substrate.

During a fourth time 204, a decompression process can be performed. In an alternate embodiment, a decompression process is not required. During the fourth time 204, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 2,500 psi and raising the pressure to above approximately 2,500 psi. In one embodiment, the pressure can be lowered by venting through the exhaust control system 150. The pressure can be increased by adding high-pressure carbon dioxide. In an alternate embodiment, during a portion of the fourth time 204, one or more additional pressures may be established.

Process steps 202, 203, and 204 can be repeated a number of times to achieve a desired process result, and a unique process recipe can be established for each different combination of the process steps. A process recipe can be used to establish the process parameters used during the different process recipes. In addition, the process parameters can be different during the different process steps. For example, a process recipe established for etching BPSG material can comprise isopropyl alcohol (IPA) and hydrofluoric (HF) acid

In one embodiment, a first etching/cleaning step can be performed followed by at least three decompression cycles when processing BPSG material. In an alternate embodiment, one or more decompression cycles may be used after an etching/cleaning process used with a BPSG material.

During the fifth time 205, a rinsing process can be performed. In the illustrated embodiment, a single step rinsing process is shown, but this is not required. Alternately, a multi-step rinsing process can be performed. In another embodiment, a variable pressure rinsing process can be performed. For example, this can be accomplished by lowering the pressure to below approximately 2,500 psi and raising the pressure to above approximately 2,500 psi. The pressure can be increased by adding high-pressure carbon dioxide.

In one embodiment, a rinsing pressure is established during the fifth time 205 using supercritical carbon dioxide. For example, the processing chamber can be pressurized to above approximately 2500 psi. In addition, a rinsing chemistry can be introduced into the processing chamber. Then, the rinsing chemistry can be recirculated within the processing chamber for a first period of time to remove a post-etch residue and photoresist material from a surface of the substrate. In one embodiment, the first period of time is less than about three minutes. Alternately, the first period of time may vary from approximately ten seconds to approximately thirty minutes. Furthermore, additional rinsing chemistry and/or supercritical fluid may be provided.

In an alternate embodiment, the rinsing chemistry may be injected at a lower pressure; the pressure of the processing chamber can be increased; and the rinsing chemistry can be recirculated within the processing chamber for a period of time.

During a sixth time 206, a decompression process can be performed. In an alternate embodiment, a decompression process is not required. During the sixth time 206, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 2,500 psi and raising the pressure to above approximately 2,500 psi. In one embodiment, the pressure can be lowered by venting through the exhaust control system 150, and the pressure can be increased by adding supercritical carbon dioxide.

Process steps 205 and 206 can be repeated a number of times to achieve a desired process result, and different rinsing recipes can be established for each different combination of the process parameters. A rinsing recipe can be used to establish the rinsing chemistry, rinsing time, and number of decompression cycles.

In one embodiment, the process chemistry used during one or more steps in the rinsing process used with BPSG material can be injected at a pressure above approximately 2200 psi and circulated at a pressure above approximately 2700 psi. In an alternate embodiment, the process chemistry used during one or more steps in the rinsing process used with BPSG material can be injected at a pressure above approximately 2500 psi and circulated at a pressure above approximately 2500 psi.

In one embodiment, processing a first type of BPSG material can require a first sequence of processes. For example, a first sequence of processes can include a first etching/cleaning step followed by a first rinsing step, a second etching/cleaning step followed by a second rinsing step, a third etching/cleaning step followed by a third rinsing step, and a fourth rinsing step. In addition, the etching/cleaning chemistry can include BLO and HF, and the rinsing chemistry can include IPA.

In another embodiment, processing a second type of BPSG material can require a second sequence of processes. For example, a second sequence of processes can include a first etching/cleaning step, a second etching/cleaning step, a rinsing step, and a drying step. In addition, the first etching/cleaning step chemistry can include BLO, the second etching/cleaning step chemistry can include IPA and HF, and the rinsing chemistry can include butylene carbonate.

In an additional embodiment, processing a third type of BPSG material can require a third sequence of processes. For example, a third sequence of processes can include a first etching/cleaning step, a second etching/cleaning step, a third etching/cleaning step followed by a rinsing step, and an additional rinsing step. In the first and second step, the etching/cleaning chemistry can include IPA and HF; in the third step, the etching/cleaning chemistry can include oxalic acid and IPA; and the rinsing chemistry can include IPA. In other cases, the first, second, and third steps can include oxalic acid and IPA; and the rinsing chemistry can include IPA.

Process steps 202, 203, 204, 205, and 206 can be repeated a number of times to achieve a desired process result for a particular material, and different combinations of etching/cleaning recipes and rinsing recipes can be established for each different combination of the process parameters. A rinsing recipe can be used to establish the rinsing chemistry, rinsing time, and number of decompression cycles.

During a seventh time 207, one or more additional processing steps can be performed. In an alternate embodiment, an additional processing step is not required. During the seventh time 207, a drying step, a rinsing step, a cleaning step, a push-through step, or an etching step, or a combination thereof can be performed.

During an eighth time 208, one or more decompression cycles and one or more compression cycles can be performed as described above. In an alternate embodiment, additional decompression cycles and compression cycles may not be required.

During a ninth time 209, the processing chamber 108 can be returned to lower pressure. For example, after the decompression and compression cycles are complete, then the processing chamber can be vented or exhausted to a transfer system pressure. For substrate processing, the chamber pressure can be made substantially equal to the pressure inside of a transfer system (not shown) coupled to the processing chamber. In one embodiment, the substrate can be moved from the processing chamber into the transfer, and moved to a second process apparatus or module to continue processing.

In the illustrated embodiment shown in FIG. 2, the pressure returns to an initial pressure P₀, but this is not required for the invention. In alternate embodiments, the pressure does not have to return to P₀, and the process sequence can continue with additional time steps such as those shown in time steps 201, 202, 203, 204, 205, 206, 207, and/or 208.

The graph 200 is provided for exemplary purposes only. It will be understood by those skilled in the art that a supercritical process can have any number steps having different time/pressures or temperature profiles without departing from the scope of the invention. Further, any number of cleaning and rinse processing sequences with each step having any number of compression and decompression cycles are contemplated. In addition, as stated previously, concentrations of various chemicals and species within a supercritical processing solution can be readily tailored for the application at hand and altered at any time within a supercritical processing step.

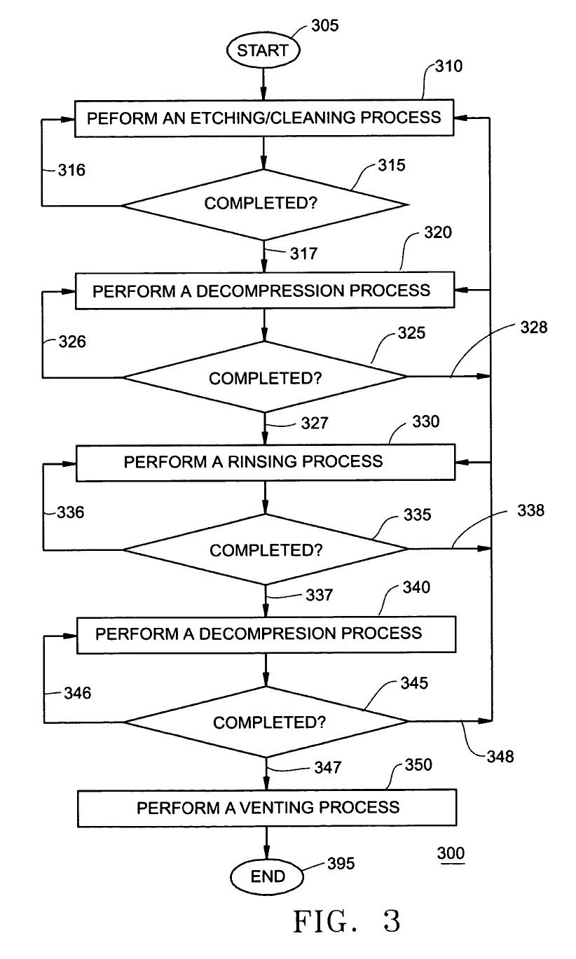

FIG. 3 illustrate a flow chart showing a method of etching features on a substrate and removing a residue from one or more feature surfaces on the substrate when the substrate is positioned on a support region within a processing chamber in accordance with embodiments of the present invention.

Procedure 300 can start in 305. The substrate to be processed can be placed within the processing chamber 108 and the processing chamber 108 can be sealed. For example, during etching/cleaning processes, the substrate being processed can have BPSG material, polysilicon material, photoresist, and/or photoresist residue thereon. The substrate, the processing chamber, and the other elements in the recirculation loop 115 (FIG. 1) can be heated to an operational temperature. For example, the operational temperature can range from approximately 40 degrees Celsius to approximately 300 degrees Celsius. In some examples, the temperature can range from approximately 80 degrees Celsius to approximately 150 degrees Celsius.

In addition, the processing chamber 108 and the other elements in the recirculation loop 115 (FIG. 1) can be pressurized. For example, a supercritical fluid, such as substantially pure CO₂, can be used to pressurize the processing chamber 108 and the other elements in the recirculation loop 115 (FIG. 1). A pump (not shown), can be used to circulate the supercritical fluid through the processing chamber 108 and the other elements in the recirculation loop 115 (FIG. 1).

In 310, an etching/cleaning process can be performed. In one embodiment, a supercritical etching/cleaning process can be performed. Alternately, a non-supercritical etching/cleaning process can be performed. In one embodiment, an etching/cleaning process 310 can include recirculating the etching/cleaning chemistry within the processing chamber 108. Recirculating the etching/cleaning chemistry over the substrate 105 within the processing chamber 108 can comprise recirculating the etching/cleaning chemistry for a period of time to remove one or more materials from the substrate.

In one embodiment, one or more push-through steps can be performed as a part of the etching/cleaning process. During a push-through step, a new quantity of supercritical carbon dioxide can be fed into the processing chamber 108 and the other elements in the recirculation loop 115 from the high-pressure fluid supply system 140, and the supercritical etching/cleaning solution along with process residue suspended or dissolved therein can be displaced from the processing chamber 108 and the other elements in the recirculation loop 115 through the exhaust control system 150. In another embodiment, supercritical carbon dioxide can be fed into the recirculation system 120 from the high-pressure fluid supply system 140, and the supercritical cleaning solution along with process residue suspended or dissolved therein can also be displaced from the processing chamber 108 and the other elements in the recirculation loop 115 through the exhaust control system 150. In an alternate embodiment, a push-through step is not required during a cleaning step.

In one embodiment, BPSG material can be etched and photoresist can be removed using process chemistry that includes one or more acids and one or more solvents.

In 315, a query is performed to determine when the etching/cleaning process has been completed. When the etching/cleaning process is completed, procedure 300 can branch 317 to 320 and continues. When the etching/cleaning process is not completed, procedure 300 branches back 316 to 310 and the etching/cleaning process continues. One or more cleaning steps and one or more cleaning steps can be performed during an etching/cleaning process. For example, different chemistries, different concentrations, different process conditions, and/or different times can be used in different etching/cleaning steps.

In 320, a decompression process can be performed while maintaining the processing system in a supercritical state. In one embodiment, a two-pressure process can be performed in which the two pressures are above the critical pressure. Alternately, a multi-pressure process can be performed. In another embodiment, a decompression process is not required. During a decompression process, the processing chamber 108 can be cycled through one or more decompression cycles and one or more compression cycles. The pressure can be cycled between a first pressure and a second pressure one or more times. In alternate embodiments, the first pressure and/or a second pressure can vary. In one embodiment, the pressure can be lowered by venting through the exhaust control system 150. For example, this can be accomplished by lowering the pressure to below approximately 2,500 psi and raising the pressure to above approximately 2,500 psi. The pressure can be increased by adding high-pressure carbon dioxide.

In 325, a query is performed to determine when the decompression process 320 has been completed. When the decompression process is completed, procedure 300 can branch 327 to 330, and procedure 300 can continue on to step 330 if no additional etching and/or cleaning is required. When the decompression process is completed and additional etching and/or cleaning is required, procedure 300 can branch 328 back to 310, and procedure 300 can continue by performing an additional etching and/or cleaning process.

When the decompression process is not completed, procedure 300 can branch back 326 to 320 and the decompression process continues. One or more pressure cycles can be performed during a decompression process. For example, different chemistries, different concentrations, different process conditions, and/or different times can be used in different pressure steps.

In one embodiment, three to six decompression and compression cycles can be performed after the etching/cleaning process is performed.

In 330, a rinsing process can be performed. In one embodiment, a single pressure rinsing process can be performed. Alternately, a multi-pressure rinsing process can be performed. In another embodiment, a variable pressure rinsing process can be performed. In one embodiment, the method of performing a rinsing process 330 can comprise the step of pressurizing the processing chamber 108 with gaseous, liquid, supercritical, or near-supercritical carbon dioxide. For example, the processing chamber can be pressurized to above approximately 2200 psi. Next, a rinsing chemistry can be introduced into the processing chamber. In the next step, the pressure of the processing chamber can be increased. Then, the rinsing chemistry can be recirculated within the processing chamber for a first period of time to remove residues from one or more surfaces of the substrate. It should be appreciated that “remove residues” encompasses removing post-etch residue and photoresist residue. In one embodiment, the first period of time is less than about three minutes. Alternately, the first period of time may vary from approximately ten seconds to approximately ten minutes.

In an alternate embodiment, one or more push-through steps (not shown) can be performed as a part of the rinsing process. During a push-through step, a new quantity of supercritical carbon dioxide can be fed into the processing chamber 108 and the other elements in the recirculation loop 115 from the high-pressure fluid supply system 140, and the supercritical rinsing solution along with process residue suspended or dissolved therein can be displaced from the processing chamber 108 and the other elements in the recirculation loop 115 through the exhaust control system 150. In another embodiment, supercritical carbon dioxide can be fed into the recirculation system 120 from the high-pressure fluid supply system 140, and the supercritical rinsing solution along with process residue suspended or dissolved therein can also be displaced from the processing chamber 108 and the other elements in the recirculation loop 115 through the exhaust control system 150.

In 335, a query is performed to determine when the rinsing process 330 has been completed. When the rinsing process is completed, procedure 300 can branch 337 to 340, and procedure 300 can continue on to step 340 if no additional etching and/or cleaning is required. When the rinsing process is completed and additional etching and/or cleaning is required, procedure 300 can branch 338 back to 310, and procedure 300 can continue by performing an additional etching and/or cleaning process.

When the rinsing process is not completed, procedure 300 can branch back 336 to 330 and the rinsing process can continue. One or more rinsing cycles can be performed during a rinsing process. For example, different chemistries, different concentrations, different process conditions, and/or different times can be used in different pressure steps.

In 340, a decompression process can be performed. In one embodiment, a two-pressure process can be performed. Alternately, a multi-pressure process can be performed. In another embodiment, decompression process 340 is not required. During a decompression process, the processing chamber 108 can be cycled through one or more decompression cycles and one or more compression cycles. The pressure can be cycled between a first pressure and a second pressure one or more times. In alternate embodiments, the first pressure and/or a second pressure can vary. In one embodiment, the pressure can be lowered by venting through the exhaust control system 150. For example, this can be accomplished by lowering the pressure to below approximately 2,500 psi and raising the pressure to above approximately 2,500 psi. The pressure can be increased by adding high-pressure carbon dioxide.

In 345, a query is performed to determine when the decompression process 340 has been completed. When the decompression process 340 is completed, procedure 300 can branch 347 to 350, and procedure 300 can continue on to step 350 if no additional cleaning or rinsing is required.

When the decompression process 340 is completed and additional etching and/or cleaning is required, procedure 300 can branch 348 back to 310, and procedure 300 can continue by performing an additional etching and/or cleaning process. In one embodiment, substantially the same etching and/or cleaning process recipe can be performed one or more times. For example, a process chemistry comprising BLO and HF can be used during three or more times to etch BPSG material having thicknesses ranging from approximately 0.1 micron to approximately 1.0 micron while not etching polysilicon material on the substrate.

When the decompression process 340 is completed and additional rinsing is required, procedure 300 can branch 348 back to 330, and procedure 300 can continue by performing an additional rinsing process. In one embodiment, substantially the same rinsing process recipe can be performed one or more times. For example, a process chemistry comprising IPA and/or another solvent can be used during at least one additional rinsing step to rinse the post-etched residue and photoresist material from features in the BPSG material having heights ranging from approximately 0.1 micron to approximately 1.0 micron.

When the decompression process is not completed, procedure 300 branches back 346 to 340 and the decompression process continues. One or more pressure cycles can be performed during a decompression process. For example, different chemistries, different concentrations, different process conditions, and/or different times can be used in different pressure steps.

In 350, a venting process can be performed. In one embodiment, a variable pressure venting process can be performed. Alternately, a multi-pressure venting process can be performed. During a venting process, the pressure in the processing chamber 108 can be lower to a pressure that is compatible with a transfer system pressure. In one embodiment, the pressure can be lowered by venting through the exhaust control system 150.

Procedure 300 ends in 395.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications may be made in the embodiments chosen for illustration without departing from the spirit and scope of the invention.

What is claimed is:

1. A method of processing a substrate having a patterned doped layer thereon, the method comprising the steps of:
positioning the substrate on a substrate holder in a processing chamber;
selectively etching the patterned doped layer using a first supercritical fluid comprising supercritical CO₂ and a cleaning/etching chemistry; and
performing a rinsing process using a second supercritical fluid comprising supercritical CO₂ and a rinsing chemistry.

2. The method of claim 1, wherein the substrate comprises semiconductor material, metallic material, dielectric material, or ceramic material, or a combination of two or more thereof.

3. The method of claim 1, wherein the patterned doped layer comprises Boron-Doped Phosphosilicate Glass (BPSG) material, polysilicon material, or photoresist residue, or a combination of two or more thereof.

4. The method of claim 3, further comprising removing the photoresist residue.

5. The method of claim 4, wherein the step of selectively etching the patterned doped layer comprises selectively etching the BPSG material.

6. The method of claim 4, wherein the step of selectively etching the patterned doped layer comprises selectively etching the polysilicon material.

7. The method of claim 1, wherein the step of selectively etching the patterned doped layer comprises:
pressurizing the processing chamber to a first pressure;
introducing the first supercritical fluid into the processing chamber;
increasing a pressure of the processing chamber to a second pressure; and
recirculating the first supercritical fluid within the processing chamber for a first period of time.

8. The method of claim 7, wherein the step of performing a rinsing process comprises the steps of:
pressurizing the processing chamber to a third pressure;
introducing the second supercritical fluid into the processing chamber; and
recirculating the second supercritical fluid within the processing chamber for a second period of time.

9. The method of claim 1, wherein the cleaning/etching chemistry comprises an organic carboxylic acid and a carrier solvent.

10. The method of claim 9, wherein the cleaning/etching chemistry comprises oxalic acid and a carrier solvent.

11. The method of claim 10, wherein the cleaning/etching chemistry comprises oxalic acid and isopropyl alcohol (IPA).

12. The method of claim 1, wherein the cleaning/etching chemistry comprises an inorganic acid and a carrier solvent.

13. The method of claim 12, wherein the cleaning/etching chemistry comprises aqueous HF and a carrier solvent.

14. The method of claim 13, wherein the cleaning/etching chemistry comprises aqueous HF and isopropyl alcohol (IPA).

15. The method of claim 1, wherein the cleaning/etching chemistry comprises a dipolar aprotic solvent, an inorganic acid, and a carrier solvent.

16. The method of claim 15, wherein the dipolar aprotic solvent comprises Dimethylsulfoxide (DMSO), Dimethylformamide (DMF), N,N-dimethylacetamide (DMAc), N-methyl-2-pyrrolidone (NMP), N-Methylmorpholine (NMM), gamma-Butyrolactone (BLO), Acetonitrile (MeCN), Ethylene carbonate (EC), or Propylene carbonate (PC), or a combination of two or more thereof.

17. The method of claim 15, wherein the inorganic acid comprises aqueous HF.

18. The method of claim 15, wherein the carrier solvent comprises alcohol.

19. The method of claim 1, wherein the rinsing chemistry comprises an alcohol and a carrier solvent.

20. The method of claim 19, wherein the alcohol comprises isopropyl alcohol (IPA).

21. The method of claim 1, wherein the rinsing chemistry comprises an alkylene carbonate and a carrier solvent.

22. The method of claim 11, wherein the alkylene carbonate comprises butylene carbonate.

23. The method of claim 7, wherein the first pressure is below approximately 2700 psi and the second pressure is above approximately 2700 psi.

24. The method of claim 7, wherein the first period of time is in a range of thirty seconds to ten minutes.

25. The method of claim 8, wherein the second period of time is in a range of thirty seconds to ten minutes.

26. The method of claim 7, wherein the step of selectively etching the patterned doped layer further comprises performing a series of decompression cycles.

27. The method of claim 26, wherein the step of performing a series of decompression cycles comprises performing one-to-six decompression cycles.

28. The method of claim 8, wherein the step of performing a rinsing process further comprises performing a series of decompression cycles.

29. The method of claim 28, wherein the step of performing a series of decompression cycles comprises performing one-to-six decompression cycles.

30. The method of claim 7, wherein the step of selectively etching the patterned doped layer further comprises a push-through process wherein the processing chamber is pressurized to an elevated pressure to push the cleaning/etching chemistry out of the processing chamber after recirculating the cleaning/etching chemistry within the processing chamber.

31. The method of claim 30, wherein the elevated pressure is above approximately 2900 psi.

32. The method of claim 1, wherein the step of selectively etching the patterned doped layer comprises:
pressurizing the processing chamber to a first cleaning pressure;
introducing a cleaning chemistry into the processing chamber;
recirculating the cleaning chemistry within the processing chamber; and
performing a series of decompression cycles.

33. The method of claim 1, further comprising the step of performing an additional process after performing the rinsing process.

34. The method of claim 33, wherein the additional process comprises a drying step, a rinsing step, a cleaning step, a push-through step, a decompression cycle, or an etching step, or a combination of two or more thereof.

35. The method of claim 1 further comprising the step of venting the processing chamber after performing the rinsing process.

36. A computer readable medium containing program instructions for execution on a controller coupled to a high-pressure processing system, which when executed by the controller, cause the high-pressure processing system to perform the steps of:
positioning a substrate on a substrate holder in a processing chamber;
selectively etching a patterned doped layer using a first supercritical fluid comprising supercritical CO₂ and a cleaning/etching chemistry; and
performing a rinsing process using a second supercritical fluid comprising supercritical CO₂ and a rinsing chemistry.

37. A method of operating a controller in a high-pressure processing system configured to process a substrate having a patterned doped layer thereon, the method comprising the steps of:
instructing the high-pressure processing system to position the substrate on a substrate holder in a processing chamber;
instructing the high-pressure processing system to selectively etch the patterned doped layer using a first supercritical fluid comprising supercritical CO₂ and a cleaning/etching chemistry; and
instructing the high-pressure processing system to perform a rinsing process using a second supercritical fluid comprising supercritical CO₂ and a rinsing chemistry.

38. Computer-executable instructions for operating a high-pressure processing system configured to process a substrate having a patterned doped layer thereon, the instruction including:
computer-executable instructions for instructing the high-pressure processing system to position the substrate on a substrate holder in a processing chamber;
computer-executable instructions for instructing the high-pressure processing system to selectively etch the patterned doped layer using a first supercritical fluid comprising supercritical CO₂ and a cleaning/etching chemistry; and
computer-executable instructions for instructing the high-pressure processing system to perform a rinsing process using a second supercritical fluid comprising supercritical CO₂ and a rinsing chemistry.
